(19) United States
(12) Patent Application Publication
(10) Pub. No.: US 2019/0325060 A1
(43) Pub. Date: Oct. 24, 2019

(54) SYMBOLIC CLUSTERING OF IoT SENSORS FOR KNOWLEDGE DISCOVERY

(71) Applicant: Cisco Technology, Inc., San Jose, CA (US)

(72) Inventors: Enzo Fenoglio, Issy-Les-Moulineaux (FR); Hugo Latapie, Long Beach, CA (US); Angelo Fienga, Rome (IT)

(21) Appl. No.: 15/960,957

(22) Filed: Apr. 24, 2018

(51) Int. Cl. G06F 17/30; G06N 99/00

(52) U.S. Cl. CPC G06F 17/30598; G06N 99/005; G06F 17/30864

(57) ABSTRACT

In one embodiment, a service in a network performs machine learning-based clustering of sensor data from a plurality of sensors in the network, to form sensor data clusters. The service maps the data clusters to symbolic clusters using a geometric conceptual space. The service infers a domain specific language from the symbolic clusters and from a domain specific ontology. The service performs, based on a query structured using the domain specific language, a lookup using the domain specific ontology to form a query response. The service sends the query response that comprises a result of the performed lookup via the network.

### TECHNICAL FIELD

The present disclosure relates generally to computer networks, and, more particularly, to the symbolic clustering of Internet of Things (IoT) sensors for knowledge discovery.

### BACKGROUND

The Internet of Things, or “IoT” for short, represents an evolution of computer networks that seeks to connect many everyday objects to the Internet. Notably, there has been a recent proliferation of “smart” devices that are Internet-capable such as thermostats, lighting, televisions, cameras, and the like. In many implementations, these devices may also communicate with one another. For example, an IoT motion sensor may communicate with one or more smart lightbulbs, to actuate the lighting in a room, when a person enters the room. However, with this expansion of the IoT also comes an ever growing body of available data and data consumers in a network.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example network device/node;

FIG. 3 illustrates an example architecture for analyzing sensor data;

FIG. 4 illustrates an example flow diagram for the symbolic clustering of sensor data; and

FIG. 5 illustrates an example simplified procedure for the symbolic clustering of sensor data for knowledge discovery.

### DESCRIPTION OF EXAMPLE EMBODIMENTS

### Overview

According to one or more embodiments of the disclosure, a service in a network performs machine learning-based clustering of sensor data from a plurality of sensors in the network, to form sensor data clusters. The service maps the data clusters to symbolic clusters using a geometric conceptual space. The service infers a domain specific language from the symbolic clusters and from a domain specific ontology. The service performs, based on a query structured using the domain specific language, a lookup using the domain specific ontology to form a query response. The service sends the query response that comprises a result of the performed lookup via the network.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or PLC networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Fog computing is a distributed approach of cloud implementation that acts as an intermediate layer from local networks (e.g., IoT networks) to the cloud (e.g., centralized and/or shared resources, as will be understood by those skilled in the art). That is, generally, fog computing entails using devices at the network edge to provide application services, including computation, networking, and storage, to the local nodes in the network, in contrast to cloud-based approaches that rely on remote data centers/cloud environments for the services. To this end, a fog node is a functional node that is deployed close to fog endpoints to provide computing, storage, and networking resources and services. Multiple fog nodes organized or configured together form a fog system, to implement a particular solution. Fog nodes and fog systems can have the same or complementary capabilities, in various implementations. That is, each individual fog node does not have to implement the entire spectrum of capabilities. Instead, the fog capabilities may be distributed across multiple fog nodes and systems, which may collaborate to help each other to provide the desired services. In other words, a fog system can include any number of virtualized services and/or data stores that are spread across the distributed fog nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

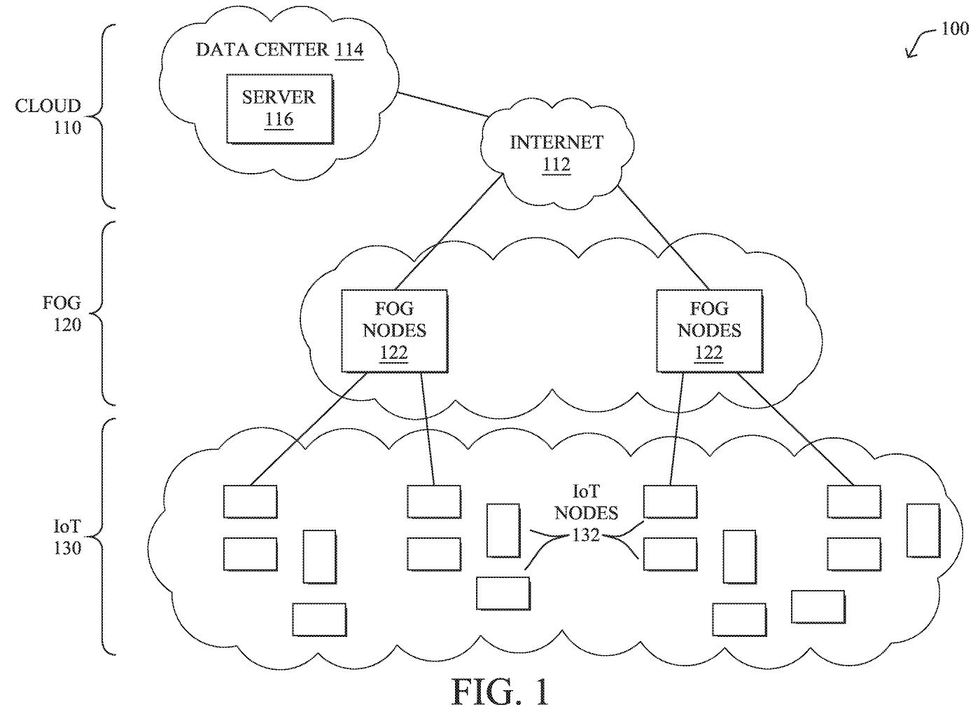

FIG. 1 is a schematic block diagram of an example simplified computer network 100 illustratively comprising nodes/devices at various levels of the network, interconnected by various methods of communication. For instance, the links may be wired links or shared media (e.g., wireless links, PLC links, etc.) where certain nodes, such as, e.g., routers, sensors, computers, etc., may be in communication with other devices, e.g., based on connectivity, distance, signal strength, current operational status, location, etc.

Specifically, as shown in the example network 100, three illustrative layers are shown, namely the cloud 110, fog 120, and IoT device 130. Illustratively, the cloud 110 may comprise general connectivity via the Internet 112, and may contain one or more datacenters 114 with one or more centralized servers 116 or other devices, as will be appreciated by those skilled in the art. Within the fog layer 120, various fog nodes/devices 122 (e.g., with fog modules, described below) may execute various fog computing resources on network edge devices, as opposed to datacenter/cloud-based servers or on the endpoint nodes 132 themselves of the IoT layer 130. Data packets (e.g., traffic and/or messages sent between the devices/nodes) may be exchanged among the nodes/devices of the computer network 100 using predefined network communication protocols such as certain known wired protocols, wireless protocols, PLC protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), PLC protocols, or other shared-media protocols where appropriate. In this context, a protocol consists of a set of rules defining how the nodes interact with each other.

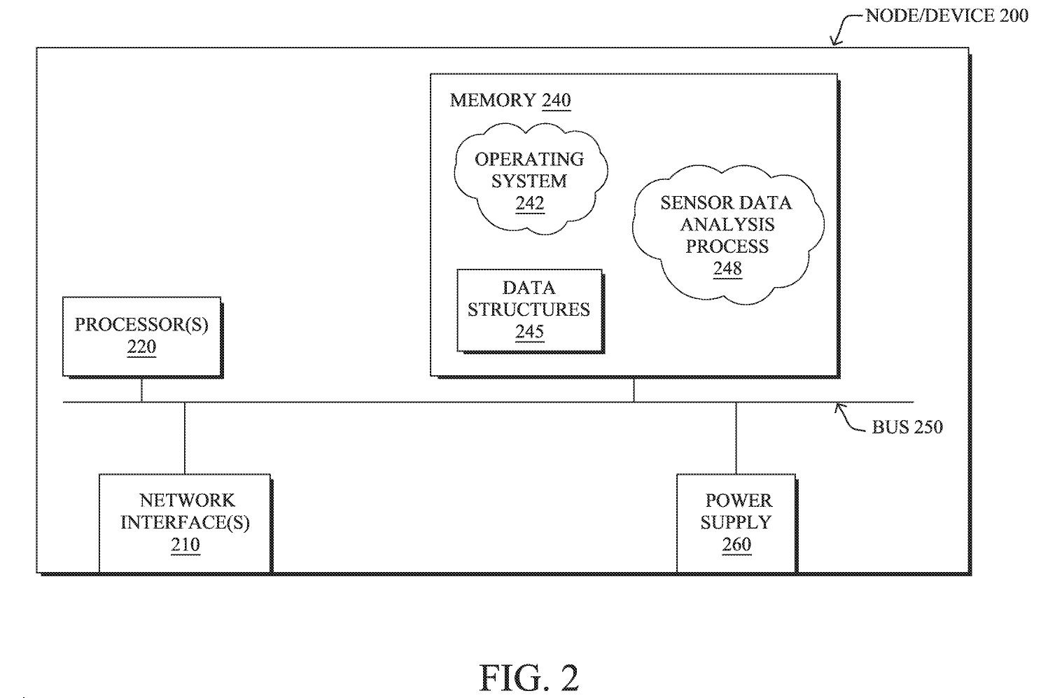

FIG. 2 is a schematic block diagram of an example node/device 200 that may be used with one or more embodiments described herein, e.g., as any of the nodes or devices shown in FIG. 1 above or described in further detail below. The device 200 may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

The network interface(s) 210 include the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration. Also, while the network interface 210 is shown separately from power supply 260, for PLC the network interface 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise hardware elements or hardware logic adapted to execute the software programs and manipulate the data structures 245. Operating system 242, portions of which is typically resident in memory 240 and executed by the processor, functionally organizes the device by, inter alia, invoking operations in support of software processes and/or services executing on the device. These software processes and/or services may comprise a sensor data analysis process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In some embodiments, sensor data analysis process 248 may use machine learning to perform the functions described herein. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. The learning process then operates by adjusting the underlying hyper parameters such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, sensor data analysis process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that sensor data analysis process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like. Accordingly, sensor data analysis process 248 may employ deep learning, in some embodiments. Generally, deep learning is a subset of machine learning that employs ANNs with multiple layers, with a given layer learning a higher level representation of the input or transforming the outputs of the prior layer.

In further embodiments, sensor data analysis process 248 may leverage symbolic learning to perform the functions described herein. In general, symbolic learning attempts to symbolically represent the problem and reasoning process. This approach differs from other learning approaches in which the reasoning itself is often concealed from outside purview, such as “hidden” layers in an ANN. In other words, symbolic learning more closely follows how humans learn and are able to explain why a particular conclusion was reached.

Symbolic learning models are what are referred to as “concepts,” which comprise a set of properties. Typically, these properties include an “intent” and an “extent,” whereby the intent offers a symbolic way of identifying the extent of the concept. For example, consider the intent that represents motorcycles. The intent for this concept may be defined by qualities such as “having two wheels” and “motorized,” which can be used to identify the extent of the concept (e.g., whether a particular vehicle is a motorcycle).

Sensor data analysis process 248 may also leverage conceptual spaces, which are a proposed framework for knowledge representation by a cognitive system on the conceptual level that provides us with a natural way of representing similarities. Notably, qualities associated with a particular concept often lie on a sliding scale, as opposed to being strictly binary. Conceptual spaces enable the interaction between different type of representations as an intermediate level between sub-symbolic and symbolic representations. A conceptual space is a metric space that allows for the measurement of semantic distances between instances of concepts and for the assignment of weights to their quality dimensions to represent different contexts. More formally, a point in a concept space S may be represented by an n-dimensional conceptual vector v=<d₁, . . . , dₙ> where dᵢ represents the quality value for the i^{th} quality dimension. For example, consider the concept of taste. A conceptual space for taste may include the following dimensions: sweet, sour, bitter, and salty, each of which may be its own dimension in the conceptual space. The taste of a given food can then be represented as a vector of these qualities in a given space (e.g., ice cream may fall farther along the sweet dimension than that of peanut butter, peanut butter may fall farther along the salty dimension than that of ice cream, etc.). By representing concepts within a geometric conceptual space, sensor data analysis process 248 can then determine similarities in geometric terms, based on the distances between the vectors/points in the conceptual space. In addition, similar objects can be grouped in conceptual space regions through the application of clustering techniques.

Said differently, a conceptual space is a framework for representing information that models human-like reasoning to compose concepts using other existing concepts. Note that these representations are not competing with symbolic or associationism (connectivism) representations. Rather, the three kinds can be seen as three levels of representations of cognition with different scales of resolution.” Namely, a conceptual space is built up from a geometrical representations based on a number of quality dimensions that complements the symbolic and Deep Learning models representing an operational bridge between them. Here, similarity between concepts is just a matter of metric distance in the conceptual space in which they are embedded (embedding=semantic representation).

As noted above, there are many IoT sensors today that provide detailed information of multiple phenomena. The number of such sensors is increasing daily and there will be even more sensors in the future that will have the ability to provide much more information of the surrounding environment in a very flexible way. Moreover, sensors are quickly acquiring the capability to move and provide environmental information in multiple areas, according to specific data gathering schemes like sensor connected to drones that add positioning capabilities. All of this sensor information can constitute an incredible value to decision makers, if processed and abstracted in a way that answers what, where, when, and how to a given user.

By way of example, consider the case in which a user sees smoke rising in the distance. The user may intuitively associate the smoke with “fire,” but may not know any other details, such as where the fire is actually located, what the extent of the fire is, how the fire is moving, when the fire started, etc. Conversely, IoT sensors located throughout the area may capture various contextual information, such as temperature, CO and/or CO₂ levels, location information, images or video, and the like, that are all related to the fire and can be used to answer the questions of the user. However, in their raw forms, this disparate collection of sub-symbolic sensor data does not actually answer the user's direct questions at the conceptual level. Thus, while knowledge can be derived from the sensor data, data transformation and analysis is required, to convert the sensor data into meaningful information for the user.

Symbolic Clustering of IoT Sensors for Knowledge Discovery

The techniques herein allow for knowledge discovery and advertisement in IoT and other sensor networks, which can also be extended to knowledge acquisition and sharing capabilities, as well. In some aspects, the techniques herein introduce a semantic transformation approach that combines sub-symbolic, unstructured sensor data with mined people opinions/intentions feedback for the same ecosystem, to derive a (dynamic) domains specific language (DSL) and framework for knowledge discovery and advertisement. This knowledge can be used, for example, for predictive analytics and data visualization within a domain-specific modelling environment that makes problem specification easier for domain experts. In further cases, knowledge advertisements can be used as part of a service that enables user to structure queries in terms of the DSL framework to leverage information available from the various sensors in the network.

Specifically, according to one or more embodiments of the disclosure as described in detail below, a service in a network performs machine learning-based clustering of sensor data from a plurality of sensors in the network, to form sensor data clusters. The service maps the data clusters to symbolic clusters using a geometric conceptual space. The service infers a domain specific language from the symbolic clusters and from a domain specific ontology. The service performs, based on a query structured using the domain specific language, a lookup using the domain specific ontology to form a query response. The service sends the query response that comprises a result of the performed lookup via the network.

Illustratively, the techniques described herein may be performed by hardware, software, and/or firmware, such as in accordance with the sensor data analysis process 248, which may include computer executable instructions executed by the processor 220 (or independent processor of interfaces 210) to perform functions relating to the techniques described herein.

Operationally, the techniques herein introduce a symbolic/sub-symbolic, integrated cognitive system in which sub-symbolic inputs are generated by a plurality of multimodal (IoT) sensors. In turn, symbolic representations of the sub-symbolic sensor data are implicitly transformed into knowledge that can be used for decision making in a particular domain/ecosystem in which the sensors operate. Said differently, on one side of the proposed system are sensors in a network that measure properties of the physical world, such as temperature, moisture, pressure, pollution, noise, video, location or GPS information, and the like. On the other side of the system, however, are people that cannot directly use this huge bulk of information from the sensors because the information is unstructured, atomic, non-contextual, not advertised, unrelated (e.g., sensors that are near one another may provide unrelated data), and/or not semantically summarized into understandable (semantic) knowledge that is useful for the end user.

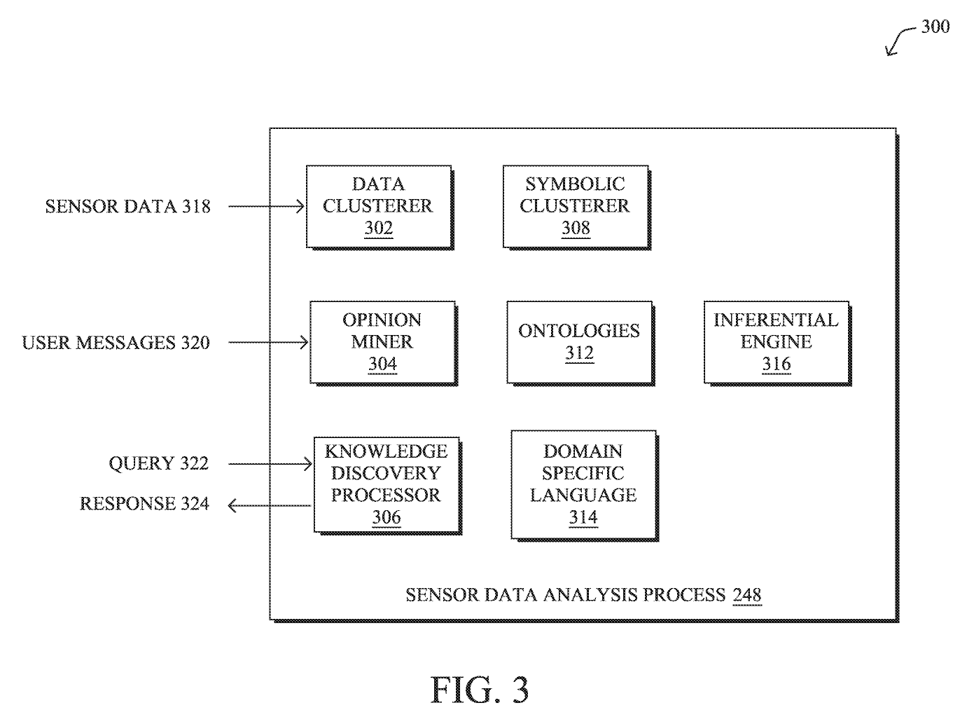

FIG. 3 illustrates an example architecture 300 for analyzing sensor data, according to various embodiments. As shown, sensor data analysis process 248 may include any or all of the sub-processes/components 302-316 shown, to implement the techniques herein. Sensor data analysis process 248 may be executed by one or more devices in a network (e.g., device 200) that operate as a service in the network. As would be appreciated, the functionalities of components 302-316 shown may be combined, omitted, or integrated into other processes, as desired.

In various embodiments, sensor data analysis process 248 may include a data clusterer 302 configured to perform data clustering on sensor data 318. As shown, sensor data analysis process 248 and, more specifically, data clusterer 302 may receive sensor data 318 from any number of sensors deployed in a network. For example, sensor data 318 may include, but is not limited to, captured video or images, captured audio, temperature readings, pressure readings, location information, pressure readings, humidity readings, power readings, combinations thereof, or the like. In turn, data clusterer 302 may perform an initial data (sub-symbolic) clustering of the sensor data 318. In the case of an IoT sensor network, for example, data clusterer 302 can be performed in the fog (e.g., fog layer 120 in FIG. 1), to cluster sensor data 318.

The purpose of data clusterer 302 building data clusters is to simplify decision making by collecting data regarding those situations, observations, or objects in the same group that require a similar decision or action that may contribute to making an educated decision. For example, in the case of a particular location, sensor data 318 from that location and from within a certain timeframe can be clustered by data clusterer 302. In some embodiments, data clusterer 302 may cluster sensor data 318 using a machine learning-based clustering approach, such as unsupervised learning with multimodal autoencoders or the like.

In various embodiments, sensor data analysis process 248 may also include an opinion miner 304 configured to mine opinions and intentions from user messages 320. Generally, user messages 320 may be associated with a particular domain, such as a location (e.g., city, building, etc.), industry (e.g., oil and gas, transportation, etc.), organization (e.g., school, company, etc.), or the like. User messages 320 may comprise any form of electronic communication such as, but not limited to, email, social media posts, instant messages, browser typesets activity, combinations thereof, or the like. During execution, opinion miner 304 may aggregate user messages 320 to provide an accurate gauge of the feelings of the majority of users associated with the domain under test. This relates not only to how people in the domain feel, but also why they feel the way they do and why they react. As would be appreciated by one skilled in the art, opinion miner 304 may use natural language syntax and semantics analysis, to identify the user opinions/intentions from user message 320. In various embodiments, the identified aggregated opinions/intentions from opinion miner 304 may be used as semantic feedback to the inferential engine 316, as detailed below. From a privacy perspective, user messages 320 may be collected only from public sources and/or with the consent of the participating users, in various implementations. However, those skilled in the art will also understand that aggregating data to pre-defined user groups is already a way to enforce individual privacy protection de-identifying by aggregation.

Sensor data analysis process 248 may also include a symbolic clusterer 308 that may symbolically cluster the data clusters from data clusterer 302. Generally speaking, symbolic learning and symbolic clustering refers to a type of learning from observations, as opposed to learning from examples, which are used to summarize data into understandable knowledge. To be effective, symbolic clustering includes knowledge of the goals, purposes, opinions, and intentions associated with the problem under investigation. In some embodiments, the data representations from opinion miner 304 may be used to bias the symbolic clustering by symbolic clusterer 308 to the most relevant semantic information.

In various embodiments, symbolic clusterer 308 may leverage conceptual spaces to provide a geometrical framework for modeling and managing the various concepts involved. In general, a conceptual space may be an n-dimensional geometric space, where each dimension represents a different quality. Note that conceptual spaces are complimentary to symbolic models and deep learning approaches. Symbolic clusterer 308 may be implemented using infoGAN, which employs a generative adversarial network (GAN) to maximize the mutual information between an observation and a subset of latent variables. Other approaches are also possible to implement symbolic clusterer 308, such as SCLUST or the like.

Sensor data analysis process 248 may also include inferential engine 316 configured to combine the symbolic clustering from symbolic clusterer 308 and the opinions/intentions mined by opinion miner 304 to generate proper ontologies 312. Here, the opinions/intentions from opinion miner 304 may act as semantic feedback. In various embodiments, ontologies 312 are the vehicle by which the captured knowledge from sensor data 318 can be modeled and shared among the various applications in the specific domain. Using modern ontology techniques, inferential engine 316 may begin with a static knowledge base ontology, such as one based on the W3C Web Ontology Language (OWL), that captures common concepts and properties valid for all domains of interest that is not inferred from the clustered sensor data from data clusterer 30 (e.g., it can provide rules for existing HW resources, network infrastructures, etc.). For the static ontology in ontologies 312, process 248 may also support the ingestion of a large corpus of pre-defined ontologies.

During operation, inferential engine may also enhance the static base ontology in ontologies 312 with domain specific ontology information captured (inferred) from the multiple layers of knowledge of the sensor data clusters, together with the opinion/intention metadata mined by opinion miner 304, to capture the contextual, dynamic information generated in the domain under test by the sensors and people interactions.

In various embodiments, inferential engine 316 may also be configured to infer a domain specific language 314 from the ontology 312 that describes the specific domain. In general, a domain-specific language is a programming language targeted at producing solutions in a given problem domain, as opposed to general-purpose programming languages. The underline assumption is that the concepts derived from the symbolic clustering by symbolic clusterer 308 are symbols that, with relations and properties, give rise to a context free grammar production (CFG). The domain specific language 314 includes static constructs with unchanging semantics typically associated with the static ontologies 312 processed by inferential engine 316.

By inferring domain specific language 314, sensor data analysis process 248 is able to empower subject matter experts by allowing them to design solutions in terms they are familiar with and at a level of abstraction that makes most sense to them in a more direct way than using a natural language. This also allows for the creation of static and dynamic constructs operating at a higher level of abstraction requiring evolving dynamics. For example, in root cause analysis and self-healing related functionality, the semantics of constructs will vary depending on the context of the system and the data flowing through the system.

Domain specific language 314 inferred by inferential engine 316 can be used as a modelling framework for knowledge discovery. For example, knowledge discovery processor 306 may receive a query 322 structured using domain specific language 314 to perform a lookup and, in turn, return a query response 324 to the issuer of query 322. In some cases, Information Centric Networking (ICN) can also be employed in the network for content distribution, publication, and/or subscription (e.g., knowledge advertisement) of the information.

Specific application examples of the techniques herein may be predictive analytics and IoT sensors booking:
Predictive analytics uses statistical techniques, machine learning, and data mining to discover facts to make predictions about unknown future events. Some of the applications of predictive analytics for manufacturing data include fault detection and failure prediction, forecasting product demand, cost modeling for product pricing, analytics for predicting warranty and product maintenance, etc. However, many small and medium manufacturing enterprises lack the infrastructure and technical knowhow to collect, store, process, and analyze their data, and translate the data into meaningful knowledge. However, the domain-specific modelling framework introduced herein can be used for predictive analytics of, e.g., manufacturing data, to integrate the tools and techniques for predictive analytics and data visualization with a domain-specific modelling environment that makes problem specification easier for manufacturing domain experts.
In further embodiments, knowledge advertisement can also be performed to advertise the data produced by a class of sensors (e.g. air pollution) that may be useful for a decision-maker that has booked data for the same sensor class (e.g., a hospital manager planning a research on lung cancer). Other actions are also possible depending on the needs of the domain experts.

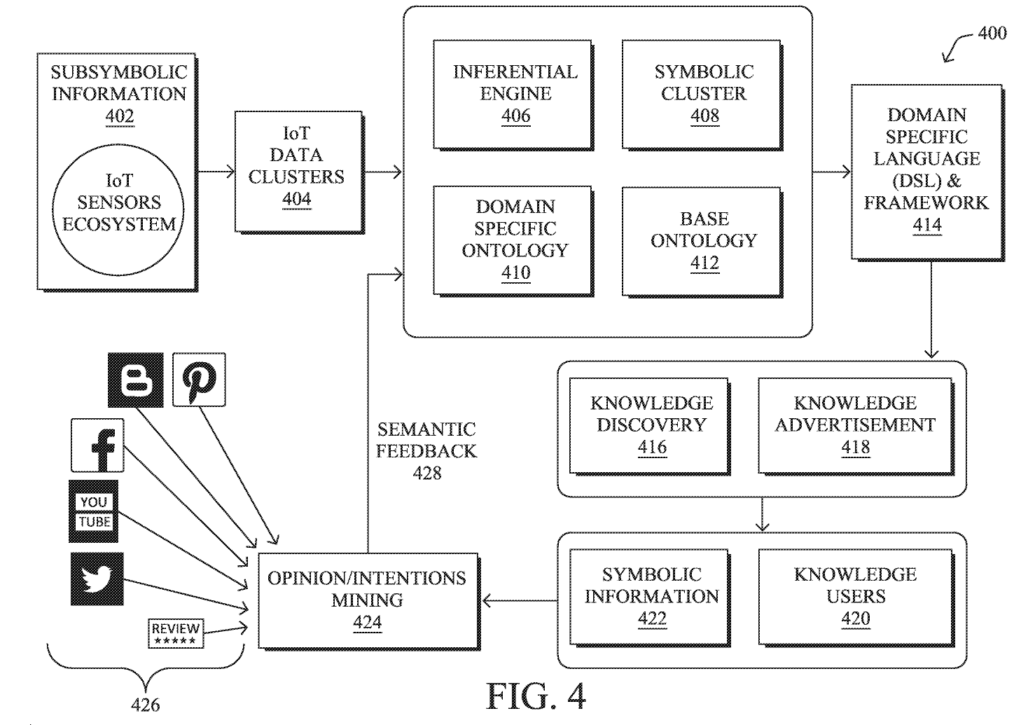

FIG. 4 illustrates an example flow diagram for the symbolic clustering of sensor data, in accordance with the techniques herein. As shown, subsymbolic information 402 (e.g., sensor data) may be obtained from any number of (IoT) sensors in a network/ecosystem. In turn, this sensor data may be clustered into data clusters 404 using machine learning-based clustering, for example. In addition to the obtained subsymbolic information 402, an opinion/intention mining process 424 may also perform opinion/intention mining on user messages 426 to mine opinion or intention metadata from these messages. As noted, user messages 426 may be social media posts, emails, online reviews, etc. This opinion/intention metadata can then be used as semantic feedback 428. In some embodiments, semantic feedback 428 can also include data regarding the perceived value of DSL 414 by knowledge users 420, thus creating a closed loop mechanism that constantly improves domain specific ontology 410 and, consequently, leading to an improved DSL 414. For example, if the system sends information to a knowledge user 420 that indicates sensor types A and B can be used for solving problem X, the user may comment, “Great, I did not now that was helpful and what about sensor type C that I've used so far for problem XT” This type of feedback can be leveraged by the system to further update domain-specific ontology 410 and DSL 414.

As noted above, an inferential engine 406 may map the data clusters 404 to symbolic clusters 408, such as through the use of a conceptual space. Inferential engine 406 may also use semantic feedback 428 from a particular domain to form a domain specific ontology 410 from a base ontology 412. By combining the concepts from the symbolic cluster 408 and this domain specific ontology 410, inferential engine 406 can infer a domain specific language and framework 414.

Using the domain specific language and framework, knowledge discovery 416 (e.g., query responses) and/or knowledge advertisement 418 are now possible, to convey the knowledge extracted from the sensor data to users 420. In turn, these users 420 may provide symbolic information 422, such as through user messages 426, which can then be mined to provide even more semantic feedback to inferential engine 406.

There are multiple use cases and industry verticals that can employ the techniques herein. These may include, for example, any or all of the following:
Smart Cities: More and more sensors are deployed in cities, some of them being at fixed locations (e.g. cameras, parking sensors, etc.), while others are movable (e.g. air sensors) or even mobile (e.g., drone-mounted, smartphone, wearable). It would be extremely useful for an urban planner to modify, even at local district level, the traffic patterns (e.g., traffic lights, variable text signals) based on the concept of “comfort” of that specific district. That implies the capability to correlate related data from multiple distinct sensors, and even potentially book times with the movable sensors (e.g. drone-mounted) for further sensor data collection. In turn, a symbolic sensor cluster could include, for instance, air quality sparse information, video from multiple cameras, etc. All these sensors provide sparse, atomic subsymbolic information that must be aggregated and converted into symbolic clusters and symbolic information before being consumed by city planners.
Oil&GAS and Energy: There are multiple use cases possible for this domain, both in predictive maintenance and in process optimization. In this latter case, if a power/oil dispersion analysis has to be performed outside the domain of the power/oil plant, data analysts will have access in real time to info from sensors they do not control directly, but that are relevant to their problem (e.g. thermal image cameras, VOC analyzers, fluid meters, power meters, CO₂ sensors, etc.). Using the techniques herein, the symbolic information will be made available as a domain specific framework, to make problem specification and modelling easier for oil rigs managers.
Emergency services/surveillance: Specific events (e.g., a fire, flooding, a storm, a public show) require ad-hoc analysis to identify and solve urgent real time issues. Analysis should be done based on the most accurate data collected on site at the time of the issue. Consider, for example, the propagation of a fire due to winds. In such a case, the behavior of the fire-front should be evaluated in real time using multiple forms of sensor data, including the information from weather forecast systems, thermal cameras on the ground and on drones, CO₂ sensors, cameras on buildings in the area, etc. Some of these sensors may even get destroyed because of the fire. Transforming them in an aggregated symbolic contextual relevant cluster is essential for problem solvers to have a relevant digitization of the problem and take the right decision ahead of real-time.

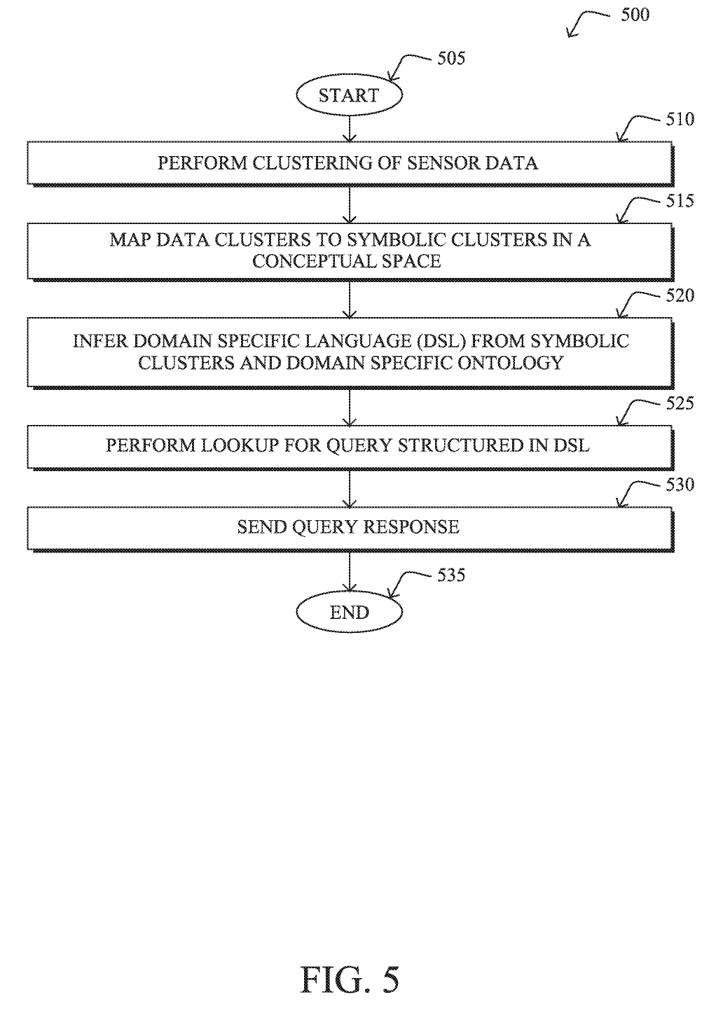

FIG. 5 illustrates an example simplified procedure for the symbolic clustering of sensor data for knowledge discovery, in accordance with one or more embodiments described herein. For example, a non-generic, specifically configured device (e.g., device 200) may perform procedure 500 by executing stored instructions (e.g., process 248), to operate as a service within the network. The procedure 500 may start at step 505, and continues to step 510, where, as described in greater detail above, the service may perform machine learning-based clustering of sensor data from a plurality of sensors in the network, to form sensor data clusters.

At step 515, as detailed above, the service may map the data clusters to symbolic clusters in a geometric conceptual space. As noted above, a geometric conceptual space may generally include any number of dimensions that represent different qualities. By mapping the sensor data into the conceptual space, thus allows a concept extracted from the sensor data to be represented on the conceptual level as a region of a conceptual space and clustered.

At step 520, the service may infer a domain specific language from the symbolic clusters and from a domain specific ontology, as described in greater detail above. In various embodiments, the service may form the domain specific ontology by combining a base ontology with opinion or intention metadata mined from the domain. Such a base ontology may be a static ontology and based on one or more existing ontologies (e.g., OWL or the like). The opinion or intention metadata may be mined from user messages in the domain, such as emails, online reviews, etc., to adapt the base ontology to a domain specific ontology. In turn, the domain specific ontology can be applied to the symbolic clusters, to infer the domain specific language.

At step 525, as detailed above, the service may perform, based on a query structured using the domain specific language, a lookup using the domain specific ontology to form a query response. By doing so, a query can be formed using the language and terminology that are commonplace among decision makers/users in the domain.

At step 530, the service may send the query response that comprises a result of the performed lookup via the network, as described in greater detail above. For example, a query may ask the service about the spread of a fire in a city. In turn, the service may form a query response that indicates the movement of the fire based on an abstraction and translation of sensor data captured by any number of sensors in the area. Procedure 500 then ends at step 535.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce an architecture and methodology that allows for greater knowledge discovery from a sensor network. Notably, by applying symbolic clustering through the use of conceptual spaces, the techniques herein allow for domain specific languages to be inferred and used to convey knowledge that has been gleaned from sensor data from the network.

While there have been shown and described illustrative embodiments that provide for the symbolic clustering of (IoT) sensors for knowledge discovery, it is to be understood that various other adaptations and modifications may be made within the spirit and scope of the embodiments herein. For example, while certain embodiments are described herein with respect to using certain learning models, the models are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
performing, by a service in a network, machine learning-based clustering of sensor data from a plurality of sensors in the network, to form sensor data clusters;
mapping, by the service, the data clusters to symbolic clusters using a geometric conceptual space;
inferring, by the service, a domain specific language from the symbolic clusters and from a domain specific ontology;
performing, by the service and based on a query structured using the domain specific language, a lookup using the domain specific ontology to form a query response; and
sending, by the service, the query response that comprises a result of the performed lookup via the network.

2. The method as in claim 1, wherein the machine learning-based clustering of the sensor data comprises applying an unsupervised multimodal autoencoder to the sensor data.

3. The method as in claim 1, wherein the domain corresponds to a particular location.

4. The method as in claim 1, further comprising:
forming, by the service, the domain specific ontology by combining a base ontology with opinion or intention metadata mined from the domain.

5. The method as in claim 4, further comprising:
mining the opinion or intention metadata from aggregated user messages associated with the domain.

6. The method as in claim 1, wherein inferring the domain specific language from the semantic clusters and from the domain specific ontology comprises:
extracting concepts from the semantic clusters;
treating the extracted concepts as symbolic information; and
applying the domain specific ontology to the symbolic information, to infer the domain specific language.

7. The method as in claim 1, further comprising:
advertising, by the service, a class of sensor data available from one or more of the plurality of sensors, based on the domain specific language.

8. The method as in claim 1, wherein the geometric conceptual space comprises a plurality of quality dimensions, each point in the conceptual space comprising a set of quality values.

9. An apparatus, comprising:
one or more network interfaces to communicate with a network;
a processor coupled to the network interfaces and configured to execute one or more processes; and
a memory configured to store a process executable by the processor, the process when executed configured to:
perform machine learning-based clustering of sensor data from a plurality of sensors in the network, to form sensor data clusters;
mapping, by the service, the data clusters to symbolic clusters using a geometric conceptual space;
inferring, by the service, a domain specific language from the symbolic clusters and from a domain specific ontology;
performing, by the service and based on a query structured using the domain specific language, a lookup using the domain specific ontology to form a query response; and
sending, by the service, the query response that comprises a result of the performed lookup via the network.

10. The apparatus as in claim 9, wherein the machine learning-based clustering of the sensor data comprises applying an unsupervised multimodal autoencoder to the sensor data.

11. The apparatus as in claim 9, wherein the domain corresponds to a particular location.

12. The apparatus as in claim 9, wherein the process when executed is further configured to:
form the domain specific ontology by combining a base ontology with opinion or intention metadata mined from the domain.

13. The apparatus as in claim 12, wherein the process when executed is further configured to:
mine the opinion or intention metadata from aggregated user messages associated with the domain.

14. The apparatus as in claim 9, wherein the apparatus infers the domain specific language from the semantic clusters and from the domain specific ontology by:
extracting concepts from the semantic clusters;
treating the extracted concepts as symbolic information; and
applying the domain specific ontology to the symbolic information, to infer the domain specific language.

15. The apparatus as in claim 9, wherein the process when executed is further configured to:
advertise a class of sensor data available from one or more of the plurality of sensors, based on the domain specific language.

16. The apparatus as in claim 9, wherein the geometric conceptual space comprises a plurality of quality dimensions, each point in the conceptual space comprising a set of quality values.

17. A tangible, non-transitory, computer-readable medium storing program instructions that cause a service in a network to execute a process comprising:
performing, by the service in the network, machine learning-based clustering of sensor data from a plurality of sensors in the network, to form sensor data clusters;
mapping, by the service, the data clusters to symbolic clusters using a geometric conceptual space;
inferring, by the service, a domain specific language from the symbolic clusters and from a domain specific ontology;
performing, by the service and based on a query structured using the domain specific language, a lookup using the domain specific ontology to form a query response; and
sending, by the service, the query response that comprises a result of the performed lookup.

18. The computer-readable medium as in claim 17, wherein the domain corresponds to a particular industry.

19. The computer-readable medium as in claim 17, wherein the process further comprises:
forming, by the service, the domain specific ontology by combining a base ontology with opinion or intention metadata mined from the domain.

20. The computer-readable medium as in claim 19, wherein the process further comprises:
mining the opinion or intention metadata from aggregated user messages associated with the domain.
